(19) United States
(12) Patent Application Publication
(10) Pub. No.: US 2022/0410060 A1
(43) Pub. Date: Dec. 29, 2022

(54) HIGH-CAPACITY DESICCANT BREATHER

(71) Applicant: DES-CASE CORPORATION, Goodlettsville, TN (US)

(72) Inventors: Olivia Willemsen, Nashville, TN (US); Eric Cooper Pride, Nashville, TN (US); Jay Michael Cooper, Nashville, TN (US); Jonathan Lee Haworth, Hendersonville, TN (US); Nikhil Rajkumar Gaikwad, Gallatin, TN (US)

(21) Appl. No.: 17/852,277

(22) Filed: Jun. 28, 2022

Related U.S. Application Data
(60) Provisional application No. 63/216,034, filed on Jun. 29, 2021.

(51) Int. Cl. B01D 53/04; B01D 53/26; G01N 21/78

(52) U.S. Cl. CPC B01D 53/0407; B01D 53/261; G01N 21/78; B01D 2257/80; B01D 2253/106; B01D 2253/116; B01D 2253/1124; B01D 2253/11; B01D 2253/104; B01D 2253/204; B01D 2253/102; B01D 2253/112; B01D 2259/45

(57) ABSTRACT

A breather is disclosed. The breather may have a breather housing, a desiccant material, and a moisture indicator. The breather housing may be configured to receive at least an air flow containing moisture. The desiccant material may be contained within the breather housing, and the desiccant material may be enclosed by a breather wall. The moisture indicator may be located within the breather housing, and the moisture indicator may be positioned between the desiccant material and an internal side of the breather wall. The moisture indicator may provide a visible representation of an amount of moisture adsorbed by the desiccant breather. The visible representation of the moisture indicator may be visually observable through the breather wall. The desiccant material may be configured to adsorb up to about forty percent (40%) of the desiccant material's weight in moisture.

### CROSS-REFERENCES TO RELATED APPLICATIONS

The present application claims priority to and benefit from a U.S. provisional patent application filed on Jun. 29, 2021, identified as U.S. Appl. No. 63/216,034.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE DISCLOSURE

The present disclosure relates generally to a desiccant breather.

### BACKGROUND

Breathers are often used in connection with machinery, equipment, or chemicals in enabling an air exchange while controlling moisture and/or particulate absorption. Breathers typically include a desiccant, so as to prevent or mitigate moisture from accumulating within the machinery or the reservoir to which the breather is attached. Breathers with an included desiccant are commonly referred to as “desiccant breathers.” Desiccant breathers offer improved filtration over standard dust caps to protect the machinery, or the reservoir to which the breather is attached, from contamination by particulates and/or moisture.

The desiccant within the desiccant breather is generally a hygroscopic material. The hygroscopic material attracts, absorbs (or adsorbs), and/or retains moisture from an air flow, such as water vapor, particularly in relatively high-humidity conditions. In current models of desiccant breathers, the desiccant may attract a significant portion of its weight in moisture, such as water vapor, thereby preventing, slowing, or mitigating a saturation of the desiccant breather with moisture. By preventing, slowing, or mitigating a saturation of the desiccant breather with moisture, the useful life of the desiccant breather may improve.

Desiccant breathers often have an indicator by which an operator or a user of the heavy- or light-duty machinery may determine that the desiccant breather has been saturated with moisture. Prevailing methods of conveying to the operator or the user that the desiccant breather has been saturated with moisture include the incorporation, inclusion, coating, or washing of color-indicating formulations in connection with the desiccant. For example, the desiccant may comprise color-indicating silica gel, such as blue silica gel or orange silica gel. Blue silica gel, which contains cobalt chloride, may change from a blue-like color to a pink-like color when the blue silica gel achieves a threshold percentage of the silica gel's weight in moisture, such as eight percent (8%). Similar to blue silica gel, orange silica gel may change from an orange-like color to a green-like color when the orange silica gel achieves a threshold percentage of the silica gel's weight in moisture.

Current models of desiccant breathers incorporating color-indicating formulations in connection with the desiccant, however, pose a number of drawbacks. First, some of the constituents used in providing the color changing nature, may have certain toxicities or alternatively, environmentally harmful properties.

In addition, the color-indicating formulation may not enable a sufficiently observable change, alteration, or conversion from a first color to a second color. For example, in some desiccants, where the desiccant has achieved a requisite level of weight in moisture, thereby enabling a conversion from the first color to the second color, the second color may not be visually apparent, such that the desiccant has reached a threshold level of weight in moisture. Accordingly, the user or operator of the machine is further constrained from selecting an alternative desiccant for unique or specified environmental conditions, due to poor color conversion in color-indicating formulations for particular desiccants.

Furthermore, color-indicating formulation for the desiccant may diminish the usefulness of the desiccant, which in turn diminishes the useful life of the desiccant breather. The incorporation of the color-indicating formulation may affect the desiccant's capacity to absorb (or adsorb) its weight in moisture. For example, the introduction of the color-indicating formulation in blue silica gel and orange silica gel may either fill or block pores (or capillaries) in the desiccant, thereby preventing the desiccant from effectively adsorbing moisture. Thus, there is a need to provide a desiccant breather that overcomes the foregoing limitations.

### BRIEF SUMMARY

The present disclosure provides a breather. Specifically, the present disclosure provides a breather having a desiccant contained therein, the breather further having a moisture indicator providing a visible representation of an amount of moisture, such as water vapor, absorbed (or adsorbed) by the desiccant.

It would be desirable to provide a breather having an indicator that provides a visible representation of an amount of moisture absorbed (or adsorbed) by the desiccant within the breather. Moreover, it would be desirable for the desiccant within the breather to absorb (or adsorb) a greater percentage of its weight in moisture than desiccant containing color-indicating formulations therein, for the purpose of extending useful life of the desiccant breather. And it would further be desirable to expand options of desiccant for the breather, such that the desiccant may be tailored to various environmental conditions in which the breather is exposed, including high- or low-temperature conditions or high- or low-humidity constraints.

In the context of a breather, optional embodiments of a breather having a breather housing, a desiccant material, and a moisture indicator is provided herein. The breather housing may be configured to receive at least an air flow containing moisture. The desiccant material may be contained within the breather housing, and the desiccant material may be enclosed by a breather wall. The moisture indicator may be located within the breather housing, and the moisture indicator may be positioned between the desiccant material and an internal side of the breather wall. The moisture indicator may provide a visible representation of an amount of moisture adsorbed by the desiccant breather.

In the context of a breather, optional aspects of the breather may include a breather housing, a desiccant material, and a moisture indicator is provided herein. The breather housing may be configured to receive at least an air flow containing moisture. The desiccant material may be contained within the breather housing, and the desiccant material may be enclosed by a transparent breather wall. The desiccant material may be substantially without a color-indicating formulation. The moisture indicator may be located within the breather housing, and the moisture indicator may be positioned between the desiccant material and an internal side of the transparent breather wall. The moisture indicator may provide a visible representation of an amount of moisture adsorbed by the desiccant breather.

In the context of a breather, an optional method of visually conveying a saturation of moisture of a desiccant material contained within a breather is provided. The method may commence with a step of receiving at least an air flow containing moisture into a breather housing of the breather. The breather housing may have the desiccant material contained therein, and the desiccant material may be enclosed by a breather wall. The method may continue with a step of capturing moisture from the air flow containing moisture into the desiccant material. The method may further continue with a step of providing a visible indication of the saturation of moisture within desiccant material by a moisture indicator adjacent the desiccant material. The visible indication may be observable through the breather wall.

In an embodiment, a breather is provided. The breather includes a breather housing, a desiccant material, and a moisture indicator. The breather housing is configured to receive at least an air flow containing moisture. The desiccant material is contained with the breather housing, and the desiccant material is enclosed by a breather wall. The moisture indicator is located within the breather housing, and the moisture indicator is positioned between the desiccant material and an internal side of the breather wall. The moisture indicator provides a visible representation of an amount of moisture adsorbed by the desiccant material.

In one aspect according to the above-referenced embodiment, the visible representation of the moisture indicator may be visually observable through the breather wall.

In another aspect according to the above-referenced embodiment, the visible representation of the moisture indicator may comprise a change in color of the moisture indicator. The change in color may be correlated to the amount of moisture adsorbed by the desiccant material.

In another aspect according to the above-referenced embodiment, the change in color of the moisture indicator may comprise at least a first color, a second color, and a third color. The first color may correspond to a generally minimal amount of moisture adsorbed by the desiccant material. The third color may correspond to an intermediate amount of moisture adsorbed by the desiccant material. The third color may correspond to a generally maximum amount of moisture adsorbed by the desiccant material.

In another aspect according to the above-referenced embodiment, the visible representation of the moisture indicator may include a gradient line. The gradient line may be correlated to an amount of moisture adsorbed by the desiccant material.

In another aspect according to the above-referenced embodiment, the moisture indicator may be coated or deposited onto at least a portion of the internal side of the breather wall.

In another aspect according to the above-referenced embodiment, the moisture indicator may be on a film. The film may be positioned against at least a portion of the internal side of the breather wall.

In another aspect according to the above-referenced embodiment, the moisture indicator may be on a blotting sheet. The blotting sheet may be positioned against at least a portion of the internal side of the breather wall.

In another particular and exemplary embodiment, a breather is provided. The breather includes a breather housing, a desiccant material, and a moisture indicator. The breather housing is configured to receive at least an air flow containing moisture. The desiccant material is contained within the breather housing, and the desiccant material is enclosed by a transparent breather wall. The desiccant material is substantially without a color-indicating formulation. The moisture indicator is located within the breather housing, and the moisture indicator is positioned between the desiccant material and an internal side of the transparent breather wall. The moisture indicator provides a visible representation of an amount of moisture adsorbed by the desiccant material.

In one aspect according to the above-referenced embodiment, the visible representation of the moisture indicator may comprise a color differential correlated to the amount of moisture adsorbed by the desiccant material.

In another aspect according to the above-referenced embodiment, the visible representation of the moisture indicator may comprise at least a first indication of an amount of moisture adsorbed by the desiccant material, a second indication of an amount of moisture adsorbed by the desiccant, and a gradient line. The gradient line may be between the first indication and the second indication, and the gradient line may be correlated to an amount of moisture adsorbed by the desiccant material of the breather.

In another aspect according to the above-referenced embodiment, the moisture indicator may be coated or deposited onto at least a portion of the internal side of the transparent breather wall.

In another aspect according to the above-referenced embodiment, the moisture indicator may be coated or deposited onto a film. The film may be positioned against at least a portion of the internal side of the transparent breather wall.

In another aspect according to the above-referenced embodiment, the moisture indicator may be on a blotting sheet. The blotting sheet may be positioned against at least a portion of the internal side of the transparent breather wall.

In another aspect according to the above-referenced embodiment, the desiccant material may comprise at least one of colorless silica gel, molecular sieve, montmorillonite clay, calcium sulfate (CaSO₄), calcium oxide (CaO), calcium chloride (CaCl₂), activated alumina, silica alumina, various pore-sized silica gel, metal-organic framework, or activated carbon, and combinations thereof.

In another aspect according to the above-referenced embodiment, the desiccant material may be configured to retain up to about forty percent (40%) of the desiccant material's weight in moisture.

In another particular and exemplary embodiment, a method of visually conveying a saturation of moisture of a desiccant material contained within a breather is provided. The method commences with a step of receiving at least an air flow containing moisture into a breather housing of the breather. The breather housing has the desiccant material contained therein, and the desiccant material is enclosed by a breather wall. The method continues with a step of capturing moisture from the air flow containing moisture into the desiccant material. The method continues with a step of providing a visible indication of the saturation of moisture within desiccant material by a moisture indicator adjacent the desiccant material. The visible indication is observable through the breather wall.

In one aspect according to the above-referenced embodiment, the visible indication may be correlated to an amount of moisture adsorbed by the desiccant material.

In another aspect according to the above-referenced embodiment, the step of providing the visible indication may further comprise producing a gradient line interposed between a first and second indication of an amount of moisture adsorbed by the desiccant material. The gradient line may be correlated to an amount of moisture adsorbed by the desiccant material indicative of an amount of moisture.

In another aspect according to the above-referenced embodiment, the desiccant material may be configured to achieve a maximum absorption of the desiccant material's weight in moisture at a rate between about 15% to about 45% slower than if the desiccant material contained a color-indicating formulation.

Unless otherwise defined, all technical and scientific terms used herein have the same meaning as commonly understood by one of ordinary skill in the art to which this invention belongs. The present invention may be embodied in other specific forms without departing from the spirit or essential attributes thereof, and it is therefore desired that the present embodiment be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

Hereinafter, various exemplary embodiments of the disclosure are illustrated in more detail with reference to the drawings

FIG. 1A is a side-elevation view of an embodiment of a breather.

FIG. 1B is cross-sectional, side-elevation view of the embodiment of the breather.

FIG. 1C is a cross-sectional, side-elevation view of an embodiment of a breather having a standpipe disposed within a breather housing, the breather having a moisture indicator positioned between a desiccant and an internal side of a breather wall.

FIG. 2 is a cross-sectional, enhanced view of the embodiment of the desiccant breather of FIG. 1C showing the moisture indicator coated or deposited onto the internal side of the breather wall.

FIG. 3 is a cross-sectional, enhanced view of the embodiment of the desiccant breather of FIG. 1C showing the moisture indicator on a film or a sheet, the film or the sheet positioned against the internal side of the breather wall.

FIGS. 4A-4E are side-elevation views of a prior-art embodiment of a breather having a desiccant containing a moisture-indicator formulation, the desiccant adsorbing certain amounts of moisture in a humid environment.

FIGS. 5A-5E are side-elevation views of an embodiment of a breather having a moisture indicator positioned between a desiccant and an internal side of a breather wall, the desiccant adsorbing certain amount of moisture in a humid environment.

FIGS. 6A-6E are side-elevation views of an embodiment of a breather having a moisture indicator positioned between a desiccant and an internal side of a breather wall, wherein the moisture indicator is positioned against at least a portion of the internal side of the breather wall.

FIG. 7A is a graphical diagram conveying an absorption of an amount of moisture in a desiccant of a prior-art embodiment of breather, wherein the desiccant contains a moisture-indicator formulation, as compared to an embodiment of the breather having a moisture indicator positioned between the desiccant and a breather wall enclosing the desiccant, where prior-art embodiment of the breather and the breather of the present disclosure are subjected to a surrounding temperature of about fifty degrees Fahrenheit (50° F.) and a humidity of seventy percent (70%).

FIG. 7B is a graphical diagram conveying an absorption of an amount of moisture in a desiccant of a prior-art embodiment of breather, wherein the desiccant contains a moisture-indicator formulation, as compared to an embodiment of the breather having a moisture indicator positioned between the desiccant and a breather wall enclosing the desiccant, where prior-art embodiment of the breather and the breather of the present disclosure are subjected to a surrounding temperature of about seventy-seven degrees Fahrenheit (77° F.) and a humidity of seventy percent (70%).

FIGS. 8A-8C are side-elevation views of an embodiment of a breather having a moisture indicator positioned between a desiccant and a breather wall, wherein the moisture indicator is embodied as a spectral indicator.

FIGS. 9A-9D are side-elevation views of an embodiment of a breather having a moisture indicator positioned between a desiccant and a breather wall, where the moisture indicator is embodied as one or more iconic indicators.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

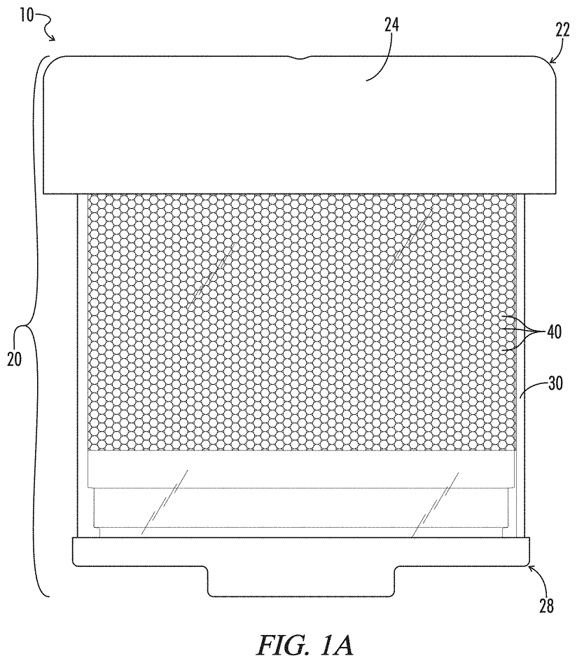

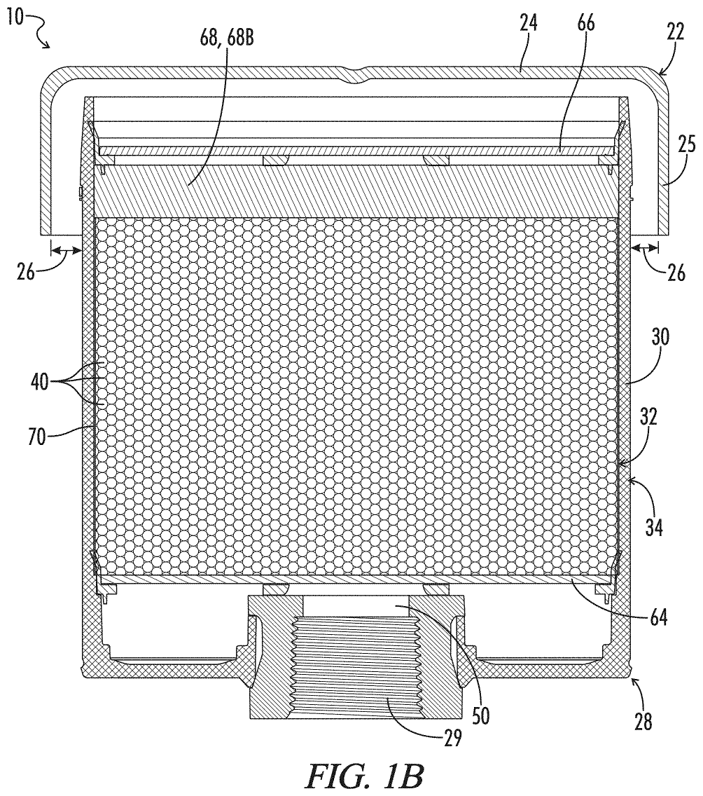

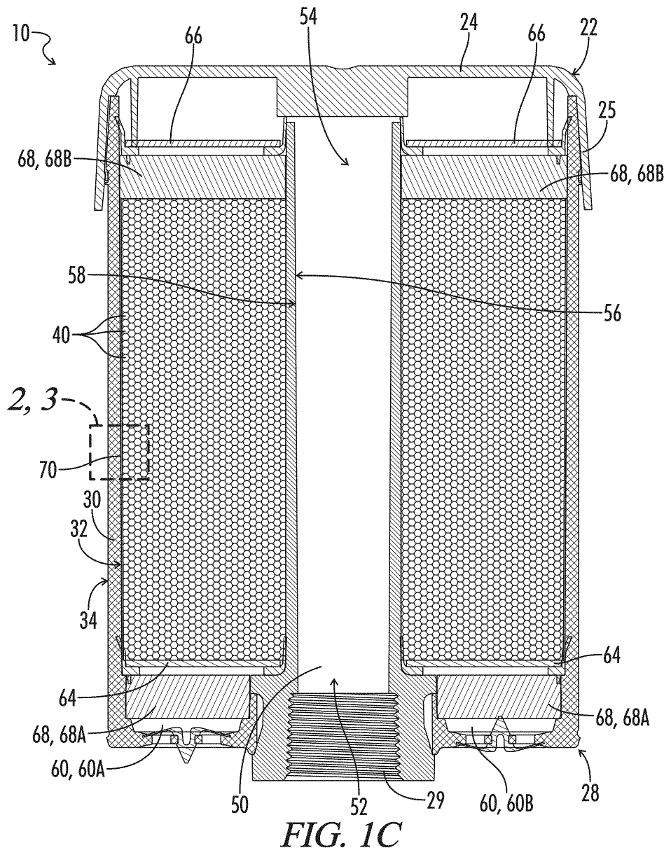

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure. Where the various figures describe embodiments sharing various common elements and features with other embodiments, similar elements and features are given the same reference numerals and redundant description thereof may be omitted below. Referring generally to FIGS. 1A-9D, various exemplary embodiments may now be described of a breather 10, or a desiccant breather 10. The various exemplary embodiments of the breather 10 may be used in conjunction with machinery, oil reservoirs, and lubricant systems in at least the following industries: pulp and paper, mining, minerals, and metals, forestry and construction, wind turbines, power generation, steel and aluminum, food and beverage, petrochemicals and refineries, and automotive, and marine (or offshore) environments.

Referring now to FIGS. 1A-1C, various embodiments may now be described of a breather 10 having a breather housing 20, a hygroscopic material, such as a desiccant material 40 (or a desiccant 40), a breather wall 30, and in optional embodiments, a standpipe 50. It may be appreciated, however, that in other embodiments the hygroscopic material may comprise a deliquescent material. In other optional embodiments, the breather 10 may, or may not, be used with an external adaptor (not shown), in which a breather attachment (not shown) may join or connect the external adaptor (not shown) to the breather 10. In further optional embodiments, the external adaptor (not shown) may use a variety of removably attachable styles to attach to the desiccant breather 10. For optional embodiments in which the breather 10 may, or may not, be used with the external adaptor (not shown), the breather 10 may be screwed into or otherwise affixed to heavy- or light-duty machinery, oil reservoirs, or lubricant systems through breather threads 29, compression fittings (not shown), or other connecting means. In optional embodiments in which the desiccant breather 10 may, or may not, be used with the external adaptor (not shown), the breather 10 may replace, substitute for, or be used in conjunction with, a dust and/or oil cap for the heavy- or light-duty machinery, the oil reservoirs, or the lubricant systems. In yet further optional embodiments, where the breather 10 is connected, affixed, threaded to, or otherwise coupled to the heavy- or light-duty machinery, oil reservoirs, or lubricant systems, an O-ring (not shown), or other pressure fitting, may be used to seal or otherwise prevent further contamination of the breather 10 and/or the heavy-or light-duty machinery, the oil reservoirs, or the lubricant systems.

Referring to FIGS. 1A-6E and 8A-9D, various embodiments may now be described of the breather 10 having the breather housing 20. The breather housing 20 may be formed of various materials, some of which may include polymers, metals, plastics, ceramics, and combinations thereof, and the breather wall 30 may be made of various materials, as described below. Generally, when viewed from a top-down perspective, or from above, the breather housing 20 may be described as generally circular or generally cylindrical, though, in optional embodiments, the shape of the breather housing 20 may be altered into any specified geometry, shape, or configuration. The breather housing 20 may contain the desiccant material 40, the desiccant 40 of which is enclosed by the breather wall 30 and adjacent to an internal side 32 of the breather wall 30. The desiccant material 40 attract and/or absorb (or adsorb) moisture, such as water vapor, from an air flow containing moisture, where the breather housing 20 receives the air flow containing moisture, as further described below.

As shown in FIG. 1B, embodiments of the breather 10 may also include a standpipe 50 supported from a base 28 of the breather housing 20. The standpipe 50 may be configured to at least receive the air flow containing moisture, and the standpipe 50 may be further configured to transmit the air flow containing moisture to the breather housing 20, and further to the desiccant material 40. In other embodiments, as shown in FIG. 1C, the standpipe 50 may be located within the breather housing 20. The standpipe 50 may be configured to at least receive the air flow containing moisture, in a region adjacent to an internal surface 56 of the standpipe 50, at a first end 52 of the standpipe 50 and transmit the air flow containing moisture through a second end 54 of the standpipe 50, and further to the desiccant material 40. In the embodiments where the standpipe 50 is located within the breather housing 20, an external surface 58 of the standpipe 50 may be adjacent to, or in contact with, the desiccant 40 located within the breather housing 20 and enclosed by the breather wall 30. Also, in the embodiments where the standpipe 50 is located within the breather housing 20, the desiccant 40 may be circumferentially positioned about the standpipe 50, such that radii from the external surface 58 of the standpipe 50 to the breather wall 30 enclosing the desiccant 40 are generally equidistant. In alternative embodiments where the standpipe 50 is located within the breather housing 20, the standpipe 50 may be positioned adjacent to at least a portion of the breather wall 30, such that the external surface 58 of the standpipe 50 is adjacent to or in contact with the internal side 32 of the breather wall 30. In other optional embodiments, the standpipe 50 may not be positioned equidistant from the breather wall 30 and thus may be biased toward one side of the breather 10. In yet further optional embodiments, the standpipe 50 may have a tapered, conical, or semi-conical shape, such that a cross-sectional width of the standpipe 50—as defined by the a diameter from an edge of the internal surface 56 of the standpipe 50 to an opposite edge of the internal surface 56—may increase or decrease from the first end 52 to the second end 54 (and vice versa).

The standpipe 50 of the present disclosure may comprise a naturally occurring material or a synthetic, the material including at least one of polypropylene or polyamide. The material of the standpipe 50 may provide resistance to vibration induced by machinery, oil reservoirs, or lubricant systems to which the breather 10 is attached, thereby dissipating impact throughout the breather 10. The material, as well as the geometrical shape, of the standpipe 50, may also enable a receipt and transmittal of an even distribution of the air flow containing moisture, thereby promoting an even saturation of the desiccant 40 by the moisture of the air flow.

In embodiments of the breather 10 having the standpipe 50 located within the breather housing 20, the standpipe 50 may contain coalescing media (not shown), the coalescing media (not shown) located within an interior of the standpipe 50 and configured to divert, trap, or capture oil from the air received by the standpipe 50. The coalescing media may be formed of a variety of different materials, including a plastic or a polymeric material, as well as fibrous materials, foamed materials, non-woven materials, molded materials, metals, ceramics, and combinations thereof.

The coalescing media (not shown) may be fitted within the standpipe 50 by engaging at least a portion of the coalescing media (not shown) against the internal surface 56 of the standpipe 50. The coalescing media (not shown) may include at least one opening (not shown) for coalescing oil when the air flow containing the oil travels from the first end 52 of the standpipe 50 to the second end 54 of the standpipe 50. Each of the at least one opening (not shown) may be dimensionally large enough to allow coalesced oil to fall into the first end 52 under a force provided by gravity. Droplets of oil may form on the coalescing media, enabling them to fall back into the machinery, oil reservoir, or lubricant system under no external forces other than gravity. Moreover, each of the least one opening (not shown) may have one or more surfaces, each of the surfaces of which define a respective closed perimeter through which air flows. In optional embodiments, the coalescing media (not shown) may form a single, continuous layer of the coalescing media (not shown), or the coalescing media (not shown) may comprise a plurality of layers having one or more openings (not shown), wherein the one or more openings (not shown) may be generally aligned or generally offset from one another. For the at least one opening (not shown), each at least one opening (not shown) may have different dimensions defined by a cross-sectional area of each of the at least one opening (not shown). It is understood that an increase in a number of layers, or an increase in the number of the at least one opening (not shown), will generally bolster, enhance, or augment coalescing of the oil because the air must flow and contact additional surfaces.

Embodiments of the breather 10 may additionally include a cap 24, or a lid 24, mounted atop the breather housing 20. The cap 24 may be mounted at the top 22 of the breather housing 20, such that a portion 25 of the cap 24 lips over the top 22 of the breather housing 20. The cap portion 25 may lip over the top 22 of the breather housing 20 about a circumferential length of the top 22 of the breather housing 20. Where the cap portion 25 lips over the top 22 of the breather housing 20, a cap space 26, or a lid space 26, may form between the cap portion 25 and the breather wall 30. The cap space 26 may be configured to receive at least the air flow containing moisture and transmit the air flow containing moisture to the breather housing 20 and onto the desiccant 40. The cap space 26 may also be configured to at least permit an escape, or a ventilation of, the air out of the breather housing 20 and into a surrounding environment. Thus, the cap space 26 may enable a two-way exchange of air, including the air containing moisture, coming into and out of the breather housing 20.

Embodiments of the breather 10 may include one or more primary valves 60. The one or more primary valves 60 may be disposed on the base 28 of the breather housing 20. As shown in FIGS. 1C, the breather 10 may include at least a first of the primary valves 60A and a second of the primary valves 60B. The one or more primary valves 60 may be configured to at least receive the air flow containing moisture, and to transmit the air flow containing moisture into the breather housing 20 and onto the desiccant 40. In optional embodiments, the one or more primary valves 60 may constitute check valves, such that the one or more primary valves 60 enable a one-way, or single-way, transmission of the air containing moisture into the breather housing 20. Alternatively, the one or more primary valves 60 may be configured to at least permit an escape, or a ventilation of, the air transmitted out of the breather housing 20 and into the surrounding environment. Thus, the one or more primary valves 60 may enable a two-way exchange of air, including the air containing moisture, coming into and out of the breather housing 20.

Embodiments of the breather 10 may further include one or more secondary valves (not shown). In optional embodiments, the one or more secondary valves (not shown) may be fitted on the cap 24, or the lid 24, of the breather housing 20. In embodiments where the one or more secondary valves (not shown) are fitted on the cap 24 of the breather housing 20, the one or more secondary valves (not shown) may be configured to at least receive the air flow containing moisture, and to transmit the air flow containing moisture into the breather housing 20 and onto the desiccant 40. In embodiments where the cap space 26 is formed (as previously described), the air flow containing moisture received within the cap space 26 may flow to the one or more secondary valves (not shown) and onto the desiccant 40. In other embodiments, the one or secondary valves (not shown) may constitute check valves, such that the one or more secondary valves (not shown) enable a one-way, or single-way, transmission of the air containing moisture into the breather housing 20. Alternatively, the one or more secondary valves (not shown) may be configured to at least permit an escape, or a ventilation of, the air transmitted out of the breather housing 20 and into the surrounding environment. Thus, the one or more secondary valves (not shown) may enable a two-way exchange of air, including the air containing moisture, coming into and out of the breather housing 20.

Embodiments of the breather 10 may further a primary filter 64 and/or a secondary filter 66, as shown in FIGS. 1B-1C. The primary filter 64 and the secondary filter 66 may comprise materials operable to filter, remove, or capture airborne contamination or particulate matters. Examples of such material include polyester, polyamide, or other synthetic fabrics, and like materials. The primary filter 64 and/or the secondary filter 66 may be configured to filter solid particulate contaminates having dimensions of about 2 microns to about 4 microns, but in optional embodiments the primary filter 64 and/or the secondary filter 66 may filter particulate contaminates having a size greater or less than the foregoing range. The primary filter 64 and the secondary filter 66 may be textured or folded in loops, ribbons, or strips, for the purpose of allowing particulate matter to release during exhalation of air (received by the breather housing 20), so as to extend a useful life of the breather 10.

In embodiments of the breather 10 having the primary filter 64, the primary filter 64 may be located proximate to the base 28 of the breather housing 20. In optional embodiments, the primary filter 64 may be positioned above or adjacent to the one or more primary valves 60 disposed on the base 28 of the breather housing 20. The primary filter 64 may be configured to filter particulate contaminates contained within air received by the one or more primary valves 60 and transmitted to the breather housing 20 and onto the desiccant 40. In embodiments where the standpipe 50 is supported from the base 28 of the breather housing 20, as in FIG. 1B, the primary filter 64 may also be configured to filter particulate contaminates contained within the air received by the standpipe 50 and transmitted to the breather housing 20 and onto the desiccant 40. In embodiments of the breather 10 having the secondary filter 66, the secondary filter 66 may be located proximate to the top 22 of the breather housing 20. In optional embodiments, the secondary filter 66 may be located in a portion of breather housing 20 covered by the cap 24 mounted on the top 22 of the breather housing 20. In other optional embodiments, the secondary filter 66 may be positioned below or adjacent to the cap space 26 and/or the one or more secondary valves (not shown). The secondary filter 66 may be configured to filter particulate contaminates contained within the air received by the cap space 26, or the one or more secondary valves (not shown), and transmitted to the breather housing 20 and onto the desiccant 40. In embodiments where the standpipe 50 is located within the breather housing 20 such that the external surface 58 of the standpipe 50 is adjacent to, or in contact with, the desiccant 40, the secondary filter 66 may be configured to filter particulate contaminates received by the standpipe 50 and transmitted from the first end 52 to the second end 54 of the standpipe 50 and onto the desiccant 40. The primary filter 64 and/or the secondary filter 66 may function as a filter for removing particulate matter, along with the desiccant 40 for trapping moisture from the air flow containing moisture, thereby providing a dual-removal system for the breather 10.

In other embodiments of the breather 10, and as shown in FIGS. 1B-1C, the breather 10 may include one or more foam pads 68, including a first foam pad 68A and/or a second foam pad 68B. The one or more foam pads 68 may be positioned between the primary filter 64, and/or the secondary filter 66, and the desiccant 40, for the purpose of capturing any oil within the air flow containing moisture. In addition to capturing said oil, the one or more foam pads 68 may effectively disperse the air flow received by the breather 10, dispersing it evenly over the desiccant 40, so as to promote uniform drying and absorption of moisture in the desiccant 40.

Referring to FIGS. 1A-6E and 7A-9D, and as previously set forth, the desiccant 40 may be enclosed by the breather wall 30. The breather wall 30 may be translucent, semi-transparent, or transparent, such that a user or operator of the breather 10 may visually observe or examine, through the breather wall 30, the desiccant material 40. In optional embodiments, the breather wall 30 may be formed by a polymeric material, including at least one of polycarbonate, polyester, copolyester, polypropylene, polyvinyl chloride, polyethylene, polyethylene terephthalate, polyamide, acrylic, or other polymer or copolymer, and combinations thereof. In further optional embodiments, the breather wall 30 may be formed by various other materials, some of which include glass, plexiglass, ceramics, and combinations thereof. The breather wall 30 may have a thickness 36, defined by a length from the internal side 32 to an external side 34 of the breather wall 30. The thickness 36 of the breather wall 30 may range from about 0.1 inches to about 0.25 inches.

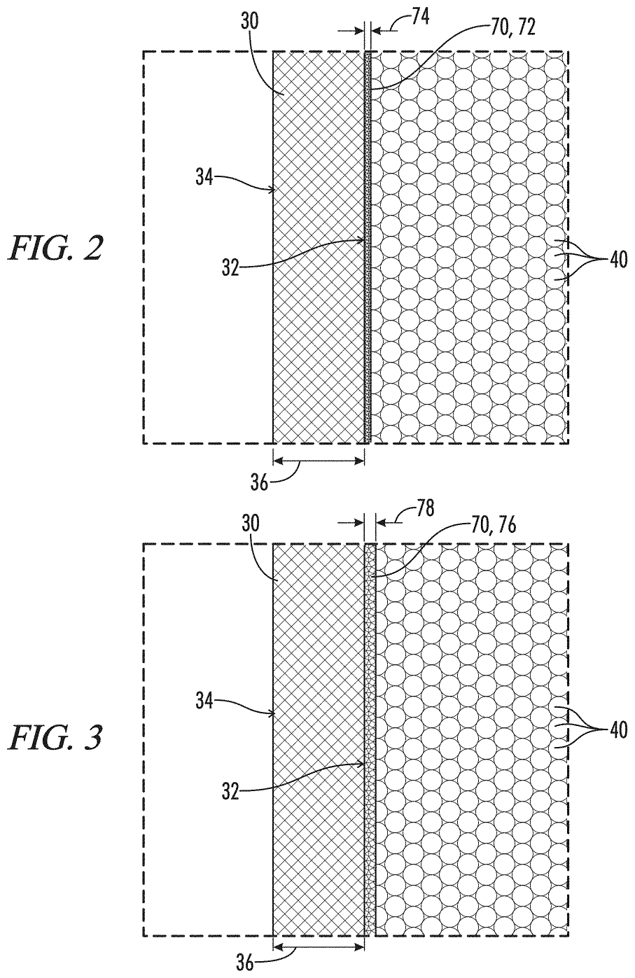

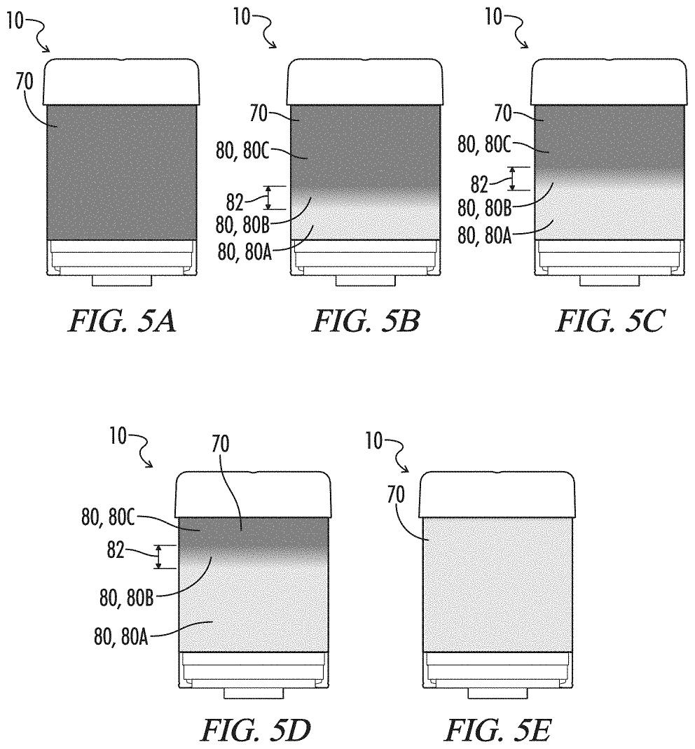

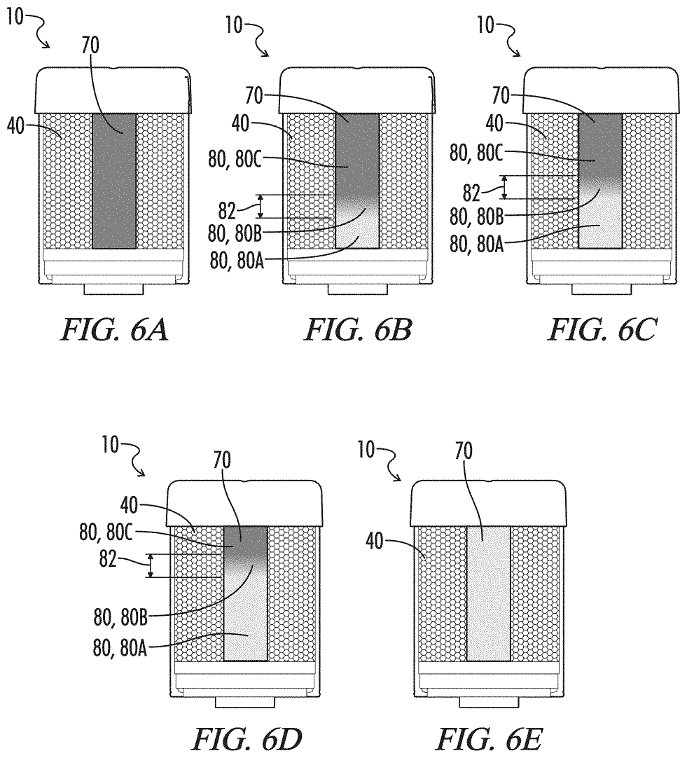

Referring to FIGS. 1B-3, the breather 10 may include a moisture indicator 70. The moisture indicator 70 may provide a visible representation, a graphic image or symbol, or another indication, of an amount of moisture absorbed (or adsorbed) by the desiccant 40. The visible representation may correspond to, or be correlated with, the amount of moisture absorbed (or adsorbed) by the desiccant 40, such that the visible representation may provide a user or operator of the breather 10 with a then-current discernible indication of an amount of moisture absorbed (or adsorbed) by the desiccant 40. In optional embodiments, and as shown in FIG. 2, the moisture indicator 70 may be coated or deposited onto at least a portion of the internal side 32 of the breather wall 30, thereby forming a moisture indicator coating 72, as illustrated in FIGS. 6A-6E; alternatively, the moisture indicator coating 72 may be coated or deposited onto and about an entirety of the internal side 32 of the breather wall 30, as illustrated in FIGS. 5A-5E. The moisture indicator coating 72 may have a thickness 74 ranging from about 0.0001 inches to about 0.040 inches. In other optional embodiments, and as shown in FIG. 3, moisture indicator 70 may be coated or deposited onto a thin film, or soaked or washed onto a blotting paper or sheet, so as to define a moisture indicator film 76, or a moisture indicator sheet 76. The moisture indicator film 76 may be positioned against at least a portion of the internal side 32 of the breather wall 30, as illustrated in FIGS. 6A-6E; alternatively, the moisture indicator film 76 may be positioned against and about an entirety of the internal side 32 of the breather wall 30, as illustrated in FIGS. 5A-5E. The moisture indicator film 76 may have a thickness 78 ranging from about 0.0001 inches to about 0.100 inches. The film, or the blotting paper or sheet, of the moisture indicator film 76 may constitute a substrate formed by a material, the material including at least one of polyester, copolyester, polypropylene, polyethylene, polyethylene terephthalate, polyamide, acrylic, or other polymer or copolymer, cellulose, blotting paper or sheet, porous-filter media, cloth, a non-woven fabric, or a resin film, or any sheet-like material, and combinations thereof.

The moisture indicator 70, whether formed as the moisture indicator coating 72, as shown in FIG. 2, or the moisture indicator film 76 (or otherwise), as shown in FIG. 3, may be formed by a number of compounds, including at least an aqueous solution (e.g., containing deionized water), a hygroscopic substance (e.g., deliquescent substance), and in optional embodiments, a solvent (e.g., an organic solvent). In embodiments having the solvent, the solvent may comprise any one or more of an organic solvent that may be soluble (or miscible) in the aqueous solution, and which may be vaporized by heating. The one or more of an organic solvent may include at least one of ethanol, 1-propanol. 2-propanol, 1-butanol, 2-butanol, 2-methyl-1-propanol, methanol, tert-butyl alcohol, methyl ethyl ketone, ethyl acetate, tetrahydrofuran, cyclohexanone, acetone, or acetonitrile, and combinations thereof.

The moisture indicator 70 may comprise a color-indicating formulation, or another formulation evidencing the visible representation (as previously described), so as to yield an observable color change to flag, signal, or indicate an absorption of moisture, such as water vapor, absorbed (or adsorbed) by the desiccant 40. The color-indicating formulation may include the hygroscopic substance. The hygroscopic substance may comprise any substance having deliquescence, such as salts and metallic salts. Examples of deliquescent substances may include at least one of calcium chloride, strontium chloride, barium chloride, magnesium chloride, sodium chloride, potassium chloride, magnesium bromide, magnesium nitrate, calcium nitrate, strontium nitrate, barium nitrate, and the like. Substances, such as magnesium chloride, sodium chloride, potassium chloride, and the like, stably react to temperature fluctuations in stable humid conditions. In some other embodiments, the color-indicating formulation may also shift in color due to a change in pH resulting from the occurrence of moisture. In other embodiments, the color-indicating formulation may also include other compounds that shift in color when the compound absorbs (or adsorbs) moisture (e.g., water vapor) from a humid environment. One example of such compound is cobalt chloride (CoCl₂), which shifts from a blue-like color in its anhydrous state to a purple- or pink-like color in its hydrated state.

In other embodiments, the moisture indicator 70 may be formed by a number of other compounds known in the art, including (without limitation) at least one or more of a wetness additive, a defoamer (i.e., an antifoam agent), an antiseptic agent, a thickening agent (i.e., a thickener), a stabilizer, an emulsifier, a pH adjuster, or various color-based pigments, and combinations thereof.

In embodiments where the moisture indicator 70 comprises the moisture indicator film 76, the moisture indicator 70 may be applied, deposited, and/or coated onto a substrate, which may include application as a thin film, or soaking or washing onto the substrate, such as a blotting paper or sheet. Other application processes of adhering the moisture indicator 70 to the substrate may be used in other embodiments. Methods may include immersion of the substrate in a formulation of the moisture indicator 70, coating with a wire bar or a roll coater, spraying by a spray nozzle, vapor deposition, screen printing, stamping, or the like depending on the composition of the substrate and the formulation of the moisture indicator 70. It is to be understood that the foregoing methods may also be applicable to coating or depositing the moisture indicator coating 72 (as further detailed below).

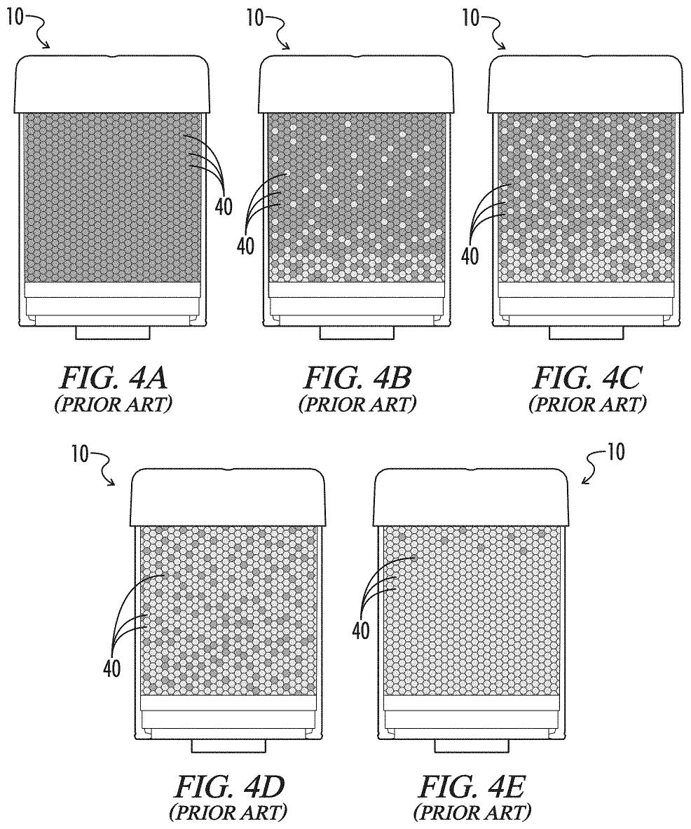

Referring to FIGS. 4A-4E, a prior-embodiment of the breather 10 having the desiccant 40 is depicted. In the prior-art embodiment of the breather 10, the desiccant material 40 may coated, washed, soaked, impregnated, or dosed with a color-indicating formulation, such as cobalt chloride. An example of the desiccant 40 comprising said color-indicating formulation is silica, and specifically silica purified and processed into a beaded, gelatin-like form (i.e., “silica gel”). In contrast to colorless silica gel—which generally does not include or is substantially without a color-indicating formulation—color-indicating silica gel may be washed or coated with a color-indicating compound, such as cobalt chloride (CoCl₂). In an anhydrous state, cobalt chloride causes the silica gel to have a blue-like color or hue (i.e., “blue silica gel”). Where the blue silica gel adsorbs around eight percent (8%) of the blue silica gel's weight in moisture, the blue silica gel changes from a blue-like color to a pink-like color. Other color-indicating silica gel, such as orange silica gel, contains methyl violet and/or copper salt. The orange silica gel may change from an orange-like color to a green-like color when reaching a certain threshold percentage of the orange silica gel's weight in moisture.

Still referring to FIGS. 4A-4E, in the prior-art embodiment of the breather 10, the desiccant 40 may include color-indicating silica gel, or another desiccant 40 with a color-indicating formulation or exhibiting color-indicating properties. Stated differently, in the prior-art embodiment of the breather 10, the desiccant 40 may be coated, washed, soaked, impregnated, or dosed with a color-indicating formulation, which provides a visible representation of an amount of moisture adsorbed by the desiccant 40. In the prior-art embodiment, the breather 10 may be connected or otherwise coupled to heavy- or light-duty machinery, oil reservoirs, or lubricant systems, wherein the breather 10 subjected to humid environmental conditions (e.g., containing moisture, such as water vapor). As is demonstrated from FIGS. 4A-4E, the desiccant 40 may adsorb varying degrees of moisture from the environment, ranging from about zero percent (0%) weight in moisture to about forty percent (40%) weight in moisture; however, it is appreciated that in other embodiments, the desiccant 40 may adsorb varying degrees of moisture from the environment, ranging from about zero percent (0%) to at or near about one hundred percent (100%) weight in moisture. For example, from 0% to 40% weight in moisture, the desiccant 40 (such as silica gel) may undergo a visually observable change in appearance, such as a color change. In FIG. 4A, where the breather 10 has not been subjected to humid conditions, the color-indicating formulation of the desiccant 40 may comprise a first color, such as a blue-like color. When air flow containing moisture from the environment is received by the breather 10 and transmitted to the desiccant 40 therein, the color-indicating formulation of the desiccant 40 (or some of the desiccant 40) may change from a first color (e.g., blue-like color) to a second color, such as a pink-like color. This transition is evident in FIGS. 4B-4D, where the desiccant 40 adsorbs between about ten percent (10%) to about thirty percent (30%) of its weight in moisture. And, as in FIG. 4E, where the desiccant 40 has adsorbed its maximum threshold percentage of its weight in the moisture—forty percent (40%), the color-indicating formulation of the desiccant 40 may comprise the second color (e.g., pink-like color). There are a number of drawbacks associated with the prior-art embodiment of the breather 10, where the desiccant 40 contains the color-indicating formulation, including those outlined in the “Background” of the disclosure. First, as is shown in FIGS. 4A-4E, the desiccant 40 provides poor visual context as to the threshold percentage of moisture (i.e., water vapor) adsorbed by the desiccant 40. This is generally because the changes in visual appearance, such as the color change, is sparsely, sporadically, and inconsistently conveyed within the color-indicating formulation of the desiccant 40. Moreover, for desiccant 40 having the color-indicating formulation, such as the silica gel containing cobalt chloride, the color-changing threshold for the desiccant 40 may be less than the maximum (or even middle) threshold of absorption of its weight in moisture. For example, the color-changing threshold for blue silica gel at eight percent (8%) is generally below silica gel's color-changing threshold of adsorbing its weight in moisture: approximately forty percent (40%). Moreover, color-indicating formulations within the desiccant 40 may worsen the absorption-performance characteristics of the desiccant 40. For example, color-indicating silica gel generally perform worse than colorless silica gel, at least with respect to the absorption capacity of the silica gel, as detailed below. This is due to the color-indicating formulation filling, blocking, or sealing the pores or capillaries of the silica gel, thereby preventing or inhibiting an effective absorption of moisture, such as water vapor.

Referring to FIGS. 5A-6E, an embodiment of the breather 10 having the desiccant 40, of the present disclosure, is depicted. In the embodiment of the breather 10 of the present disclosure, the moisture indicator 70, whether as the moisture indicator coating 72 or the moisture indicator film 76, is positioned between the desiccant 40 and the internal side 32 of the breather wall 30, as previously described herein. As shown in FIGS. 5A-5E, the moisture indicator 70 may be positioned between the hygroscopic material—the desiccant 40—and the internal side 32 of the breather wall 30, such that the moisture indicator 70 is against (or positioned along) an entirety of the internal side 32 of the breather wall 30; and, as shown in FIGS. 6A-6E, the moisture indicator 70 may be positioned between the desiccant 40 and the internal side 32 of the breather wall 30, such that the moisture indicator 70 is against (or positioned along) at a least a portion of the internal side 32 of the breather wall 30. The desiccant 40 within the breather 10 of the present disclosure may constitute any hygroscopic material, or any material that attracts, absorbs (or adsorbs), and retains moisture from an air flow, such as water vapor, as further described below. The desiccant 40 may include at least one of colorless silica gel, molecular sieve, montmorillonite clay, calcium sulfate (CaSO₄), calcium oxide (CaO), calcium chloride (CaCl₂), activated alumina, various pore-size silica gel, activated carbon, salts, metal-organic frameworks, silica alumina, or any proprietary blends or formulations, combinations thereof, or another type of desiccant. It may be appreciated, however, that in other embodiments the hygroscopic material may comprise a deliquescent material, such as calcium chloride, strontium chloride, barium chloride, magnesium chloride, sodium chloride, potassium chloride, magnesium bromide, magnesium nitrate, calcium nitrate, strontium nitrate, barium nitrate, and the like. By having the moisture indicator 70 positioned between the desiccant 40 and the internal side 32 of the breather wall 30 (as previously described), such that the desiccant 40 does not contain a moisture-indicating (i.e., color-indicating) formulation—or is at least substantially without a moisture-indicating (i.e., color-indicating) formulation—the desiccant 40 may be selected depending upon climate—or atmospheric conditions or other environmental constraints.

An example of the desiccant 40 of the breather 10 of the present disclosure includes silica purified and processed into a beaded, gelatin-like form (i.e., “silica gel”). Unlike the prior-art embodiment (as in FIGS. 4A-4E), the silica gel is generally considered to be colorless (or at least is substantially without a color-indicating formulation). In embodiment of the present disclosure, the breather 10 may be connected or otherwise coupled to heavy- or light-duty machinery, oil reservoirs, or lubricant systems, wherein the breather 10 subjected to humid environmental conditions (e.g., containing moisture, such as water vapor). As is demonstrated from FIGS. 5A-6E, the desiccant 40 may adsorb varying degrees of moisture from the environment, ranging from about zero percent (0%) weight in moisture to about forty percent (40%) weight in moisture; however, it is appreciated that in other embodiments, the desiccant 40 may adsorb varying degrees of moisture from the environment, ranging from about zero percent (0%) to at or near about one hundred percent (100%) weight in moisture. From 0% to 40% weight in moisture, the desiccant 40 does not undergo a visually observable change in appearance, such as a color change. Rather, the moisture indicator 70, whether the moisture indicator coating 72 or the moisture indicator film 76, provides a visible representation of an amount of moisture adsorbed by the desiccant 40. The visible representation may provide such indication insofar as the visible representation is correlated to the amount of moisture adsorbed by the desiccant 40. For example, in FIGS. 5A and 6A, where the breather 10 has not been subjected to humid conditions—zero percent (0%) humidity—the moisture indicator 70 may comprise a first color, such as a blue-like color. When air flow containing moisture from the environment is received by the breather 10 and transmitted to the desiccant 40 therein, the desiccant 40 may change from a first color (e.g., blue-like color) to a second color, such as a pink-like color. This transition is evident in FIGS. 5B-5D and 6B-6D, where the desiccant 40 adsorbs between about ten percent (10%) to about thirty percent (30%) of its weight in moisture. And, as in FIGS. 5E and 6E, where the desiccant 40 has adsorbed its maximum threshold percentage of its weight in the moisture—forty percent (40%), the moisture indicator 70 may comprise the second color (e.g., pink-like color). In other optional embodiments, moisture indicator coating 72 or the moisture indicator film 76 may be included in breather 10 along with desiccant 40 having a color-indicating formulation or exhibiting color-indicating properties, which may both provide for indication of the moisture content.

Still referring to FIGS. 5A-6E, the visible representation of the moisture indicator 70 may be correlated to the amount of moisture adsorbed by the desiccant 40. As previously discussed, the visible representation of the moisture indicator 70 may comprise a change in color 80, the change of color 80 being correlated to the amount of moisture adsorbed by the desiccant 40. The change in color 80 may include at least a first color 80A, a second color 80B, and a third color 80C. The first color 80A (e.g., a blue-like hue) may correspond to a generally minimal amount of moisture adsorbed by the desiccant 40, such as moisture derivative of a humidity content from about 0% to about 10%, as conveyed in FIGS. 5A and 6A. The second color 80B may correspond to an intermediate amount of moisture adsorbed by the desiccant 40, such as a moisture derivative of a humidity content from about 10% to about 30%, as depicted in FIGS. 5B-5D and 6B-6D. The second color 80B may comprise a faded, blue or purple hue, so as to evidence a transition from a blue-like color to a faded-blue color. The third color 80C (e.g., a pink-like hue) may correspond to a generally maximum amount of moisture adsorbed by the desiccant 40, such as a moisture derivative of a humidity content from about 30% to about 40%, as conveyed in FIGS. 5E and 6E. In some optional embodiments, only a first color and third color may exist indicating the generally the minimal amount of moisture adsorbed by the desiccant and the maximum amount of moisture adsorbed by the desiccant. As such, the second color may be absent or so minimal it is not easily observable and thus a person viewing the breather would only visually see the first color and the third color. Thus, in such embodiments, a first and third color as described herein can exist without a second color being visually observable. In optional embodiments, the visible representation of the moisture indicator 70 may comprise a gradient line 82, or a gradient band or wrap. The gradient line 82 may be interposed, or appear evident between, a first indication of an amount of moisture adsorbed by the desiccant 40—which may be the first color 80A—and a second indication of an amount of moisture adsorbed by the desiccant 40—which may be the third color 80C. Where the moisture indicator 70 comprises a color-indicating formulation, the gradient line 82 may appear as a polymerization between a first color and a second color, or as a spectral transition from the first color 80A to the third color 80C—such that the special transition visually evidences the second color 80B—and the gradient line 82 may inform a user of a then-current amount of moisture adsorbed by the desiccant 40. For example, the gradient line 82, which is correlated to the amount of moisture adsorbed by the desiccant 40, could inform a user as to the approximate percentage, i.e., from 0% to 40% by weight in moisture, the desiccant 40 has realized in receiving an air flow containing moisture in a humid environment. In other embodiments where the moisture indicator 70 comprises a color-indicating formulation, the gradient line 82 may comprise a color differential 82, the color differential 82 visually conveying a line, or band, of demarcation between the first color 80A and the second color 80B, or as a spectral transition from the first color 80A to the third color 80C—such that the special transition visually evidences the second color 80B. The change in color 80, the gradient line 82, or the color differential 82, as illustrated in FIGS. 5B-5D and 6B-6D, may communicate to a user (or operator) of the breather 10 that the breather housing 20 has been saturated with an amount of moisture commensurate with the amount moisture adsorbed by the desiccant 40. As used herein gradient line 82 may be generally straight, wavy or not straight, curved or angled, all while providing visual representation. The moisture indicator 70, in providing this visible representation, may inform a user of an approximate, or precise, then-current amount of moisture adsorbed by the desiccant 40, thereby allowing the user (or operator) the option to replace the desiccant 40 (or the breather 10 altogether) or to adjust the environmental conditions, e.g., alter the temperature in the surrounding environment or monitor the relative humidity within the surrounding environment.

In embodiments where the moisture indicator 70 evidences the change in color 80 or where the moisture indicator 70 comprises the color differential 82, the moisture indicator 70 may be configured to change from a blue-like color to a pink-like color, and in other optional embodiments, the moisture indicator 70 may be configured to change from an orange-like color to a green-like color when the moisture indicator 70 is subjected to humid environmental conditions. It is to be understood by one of ordinary skill in the art that the colors disclosed herein, with respect to the change in color 80 and/or the color differential 82, are descriptive of exemplary embodiments only and is not intended as limiting the spectrum of colors that may be selected.

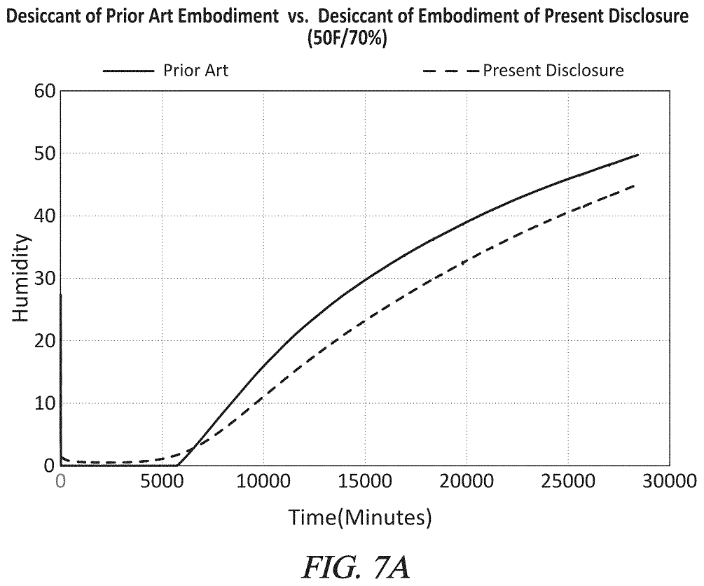

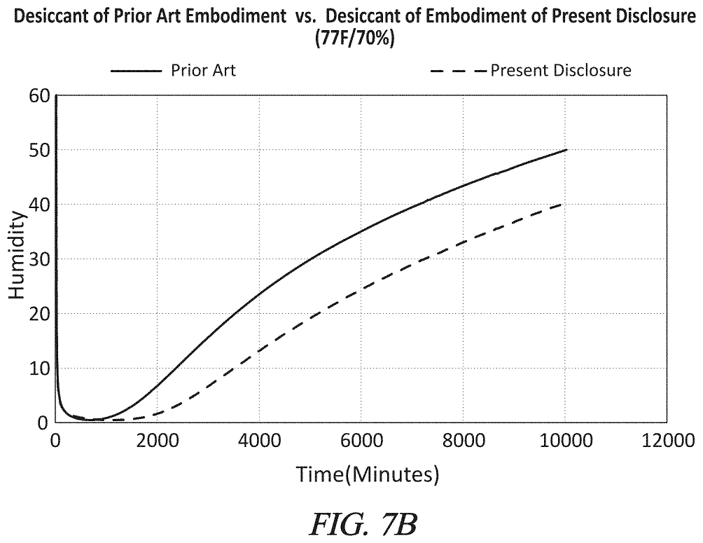

Referring to FIGS. 7A-7B, a graphical diagram conveying an absorption of an amount of moisture in the desiccant 40 of an embodiment of the breather 10 of the present disclosure, as shown in FIGS. 5A-6E, is compared against an absorption of an amount of moisture in the desiccant 40 of the prior-art embodiment of the breather 10, as shown in FIGS. 4A-4E. The absorption value of the desiccant 40 of the embodiment of the breather 10 of the present disclosure is depicted as a dashed line, whereas the absorption value of the desiccant 40 of the prior-art embodiment of the breather 10 is depicted as a non-dashed line. In FIG. 7A, the desiccant 40 is subjected to surrounding temperature of about fifty degrees Fahrenheit (50° F.) and a humidity of seventy percent (70%); and, in FIG. 7B, the desiccant 40 is subjected to a surrounding temperature of about seventy-seven degrees Fahrenheit (77° F.) and a humidity of seventy percent (70%). As shown in FIG. 7A, the prior-art embodiment of the breather 10, where the desiccant 40 contains a color-indicating formulation, adsorbs moisture from an air flow at rate more rapid than the embodiment of the breather 10 where the moisture indicator 70 is positioned between the desiccant 40 and the internal side 32 of the breather wall 30 (as previously described). As further shown in FIG. 7A, where the desiccant 40 is subjected to a temperature of about 50° F. and a humidity of 70%, the desiccant 40 of the prior-art embodiment of the breather 10 may reach a saturation of forty percent (40%) by weight in moisture in approximately 20,000 minutes and the desiccant 40 of the embodiment of the breather 10 of the present disclosure may reach a saturation of forty percent (40%) in approximately 24,500 minutes. Accordingly, the desiccant 40 of the breather 10 of the present disclosure may have an extended useful life, as reflected by a 20% improvement over when the desiccant 40 saturates (or “expires”) when adsorbing moisture. As further shown in FIG. 7B, the desiccant 40 is subjected to a temperature of about 77° F. and a humidity of 70%, the desiccant 40 of the prior-art embodiment of the breather 10 may reach a saturation of forty percent (40%) by weight in moisture in approximately 7,000 minutes and the desiccant 40 of the embodiment of the breather 10 of the present disclosure may reach a saturation of forty percent (40%) in approximately 10,000 minutes. Accordingly, the desiccant 40 of the breather 10 of the present disclosure may have an extended useful life, as reflected by a 40% improvement over when the desiccant 40 saturates (or “expires”) when adsorbing moisture. Thus, in embodiments of the breather 10 having the moisture indicator 70 positioned between the desiccant 40 and the internal side 32 of the breather wall 30—such that the desiccant 40 is without (or substantially without) a color-indicating formulation, such as the moisture indicator 70—the desiccant 40 may have a useful life (e.g., duration of maximum saturation) between about 20% to about 40% longer than prior-art embodiments of the breather 10 having the desiccant 40. In other embodiments of the breather 10, such as when a material of the desiccant 40 is different (e.g., activated alumina in lieu of silica gel), the desiccant 40 may have a useful life between about 15% to about 45% longer than prior-art embodiments of the breather 10 having the desiccant 40. In yet other embodiments of the breather 10, where the material of the desiccant 40 is different, the desiccant 40 may have a useful life ranging anywhere from about 5% to about 100% longer than prior-art embodiments of the breather 10 having the desiccant 40, though the useful life may increase at percentage or value greater than 100%.

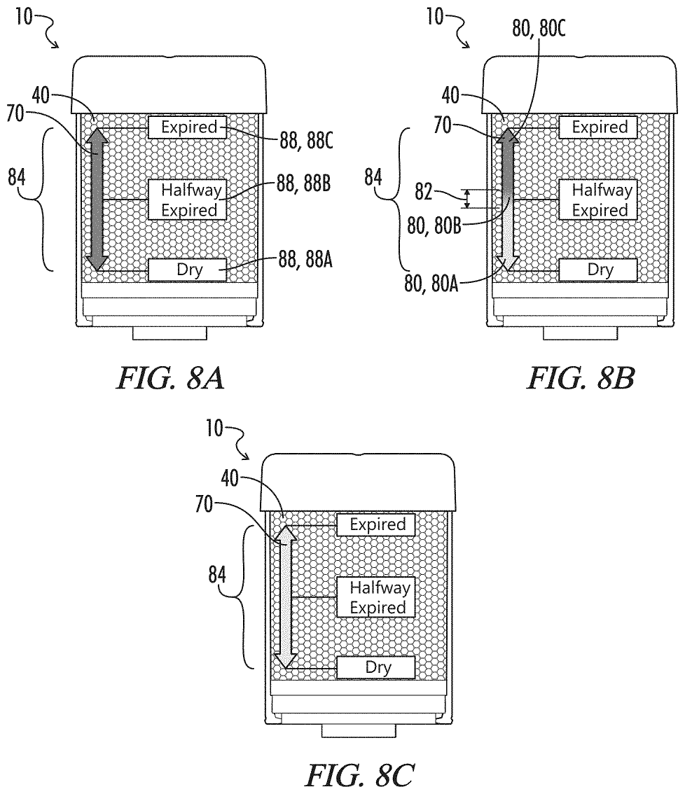

Referring to FIGS. 8A-8C, an embodiment of the breather 10 of the present disclosure is depicted, where the moisture indicator 70 embodies a spectral indicator 84. The spectral indicator 84 may provide a visible representation of an amount of moisture adsorbed by the desiccant 40, as previously disclosed herein (e.g., the change in color 80, the gradient line 82, and/or the color differential 82). As illustrated in FIGS. 8A-8C, in addition to the moisture indicator 70, embodied as the spectral indicator 84, one or more indices or markers 88 may be deposited, coated, adhered, applied, or otherwise coupled to the internal side 32 or the external side 34 of the breather wall 30. The one or more indices or markers 88 may provide the user or operator of the breather 10 with a communicable means of ascertaining the adsorbance capacity of the desiccant 40 within the breather housing 20. For example, the various one or more indices or markers 88 could include conventional text, such as “Dry” (a first index or marker 88A), “Halfway Expired” (a second index or marker 88B), and/or “Expired” (a third index or marker 88C). Each of these one or more indices or markers 88 could be directly correlated with an amount of moisture adsorbed by the desiccant 40, such as between about 0% to 40%; however, it is appreciated that in other embodiments, the desiccant 40 may adsorb varying degrees of moisture from the environment, ranging from about zero percent (0%) to at or near about one hundred percent (100%) weight in moisture. To the extent the moisture indicator 70 contains a color-indicating formulation, the moisture indicator 70 may provide a visible representation of the amount of moisture adsorbed by the desiccant 40 as the change in color 80. The change in color 80—which could include the first color 80A, the second color 80B, and the third color 80C—may be visibly conveyed to the user or operator of the breather 10, and certain transitions in the change of color 80 may be associated, or in correspondence with, the one or more indices or markers 88.

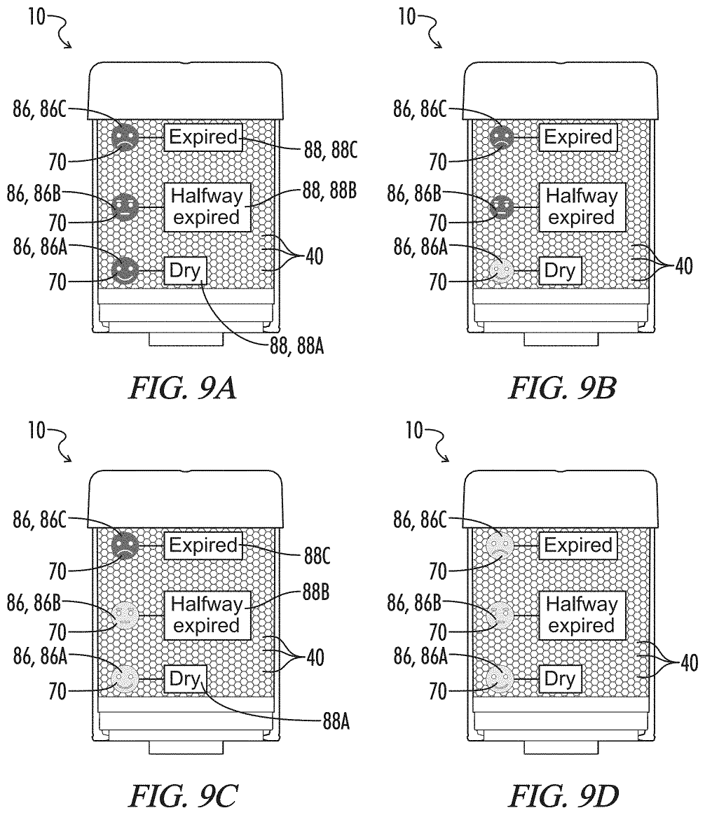

Referring to FIGS. 9A-9D, an embodiment of the breather 10 of the present disclosure is depicted, where the moisture indicator 70 embodies one or more iconic indicators 86. As shown in FIGS. 9A-9D, the moisture indicator 70 may include at least a first icon 86A, a second icon 86B, and a third icon 86C. The one or more iconic indicators 86 may provide a visible representation of an amount of moisture adsorbed by the desiccant 40, as previously disclosed herein (e.g., the change in color 80, the gradient line 82, and/or the color differential 82). Like with the spectral indicator 84, as shown in FIGS. 8A-8C, the one or more indices or markers 88 may be applied to the breather wall 30, where the moisture indicator 70 embodies the one or more iconic indicators 86. The one or more indices or markers 88 may provide the user or operator of the breather 10 with a communicable means of ascertaining the adsorbance capacity of the desiccant 40 within the breather housing 20. Each of these one or more indices or markers 88 could be directly correlated with an amount of moisture adsorbed by the desiccant 40, such as between about 0% to 40%; however, it is appreciated that in other embodiments, the desiccant 40 may adsorb varying degrees of moisture from the environment, ranging from about zero percent (0%) to at or near about one hundred percent (100%) weight in moisture. To the extent the moisture indicator 70, embodied as the one or more iconic indicators 86, contains a color-indicating formulation, the moisture indicator 70 may provide a visible representation of the amount of moisture adsorbed by the desiccant 40 as the change in color 80. The change in color 80—which could include the first color 80A, the second color 80B, and the third color 80C—may be visibly conveyed to the user or operator of the breather 10, and certain transitions in the change of color 80 may be associated, or in correspondence with, the one or more indices or markers 88.

In some optional embodiments, one or more indices or markers 88 may not be visible until a certain moisture level is accumulated by the desiccant. In such embodiments, the one or more indices or markers may have generally the same appearance as the breather wall or the film or blotting paper or sheet and thus are initially less visible, and with the accumulation of moisture by the desiccant, become more pronounced or visible. In other optional embodiments, the one or more indices or markers may have a contrasting appearance to the breather wall or the film or blotting paper or sheet and thus be initially visible, and with the accumulation of moisture by the desiccant, the one or more indices or markers disappear, fade, or become less visible.

The present disclosure is intended in no way to be limiting at to what may be conveyed vis-à-vis the moisture indicator 70, whether as the moisture indicator coating 72 or the moisture indicator film 76. In other embodiments, the moisture indicator 70 may convey a symbol indicative, and correlated to, an amount of moisture adsorbed by the desiccant 40. The symbol may include at least one of images, graphics, text, emojis, logos, marks, emblems, or other symbols, or combinations thereof. The disclosure herein identifies and describes a limited number of indications, signs, or signals as to when the moisture indicator 70 of the breather 10 may evidence a saturation of the desiccant 40, whether no saturation, an intermediate level of saturation, and/or a near-maximum level of saturation have been achieved. The limited number of indications, signs, or signals as to when and/or how the moisture indicator 70 of the breather 10 may evidence or convey a saturation (or no saturation) of the desiccant 40, as disclosed and described herein, are merely representative, and do not constitute the universe of indications, signs, or signals.

A method of visually conveying a saturation (or absorption) of moisture of the desiccant 40 within the breather 10 may be described as follows. The method may commence with a step of receiving at least the air flow containing moisture into the breather housing 20. As previously described, the breather housing 20 may have the desiccant 40 contained therein and enclosed by the breather wall 30. The breather housing 20 may receive the at least air flow containing moisture by the standpipe 50, the one or more primary valves 60, the one or more secondary valves (not shown), and/or the cap space 26, as previously described herein, and each of the foregoing may thereby transmit the air flow containing the moisture to the desiccant 40. The method may continue with a step of capturing, or hydrophilically adsorbing, moisture from the air flow containing moisture into, or by and through, the desiccant 40. The method may then continue with a step of providing a visible indication of the saturation of moisture within the desiccant 40 by the moisture indicator 70. The moisture indicator 70 may be positioned adjacent to the desiccant 40, or otherwise positioned between the desiccant 40 and the internal side 32 of the breather wall 30. The visible indication may be observable, by a user or operator of the breather 10, through the breather wall 30. The visible indication of the moisture indicator 70, as previously described, may be correlated to or associated with, an amount of moisture adsorbed by the desiccant 40. The method may further continue with the step of providing the visible indication further including a sub-step of producing the gradient line 82. The gradient line 82, or the color differential 82, may be interposed between a first and second indication of an amount of moisture adsorbed by the desiccant 40 (as previously described), and the gradient line 82 correlated to a then-current amount of moisture adsorbed by the desiccant 40 indicative of an amount of moisture in the breather 10. The desiccant 40 of the breather 10 of the present disclosure may achieve a maximum absorption of the desiccant's 40 weight in moisture at a rate between about 15% to about 45% slower than if the desiccant 40 contained a color-indicating formulation, as previously described with respect to prior-art embodiments.

In the embodiment of the breather 10 of the present disclosure, the desiccant 40 may include various hygroscopic material, or various material that attracts, adsorbs, and/or retains moisture from an air flow, such as water vapor. In some embodiments, the desiccant 40 may comprise at least one of colorless silica gel, molecular sieve, montmorillonite clay, calcium sulfate (CaSO₄), calcium oxide (CaO), calcium chloride (CaCl₂), activated alumina, silica alumina, various pore-size silica gel, activated carbon, salts, metal-organic frameworks, or any proprietary blends or formulations, and combinations thereof.

In some embodiments, the desiccant 40 may comprise colorless silica gel. Silica gel is a granular, porous form of silicon dioxide (SiO₂), the same material of which is naturally discovered or found in quartz sand. Silica gel may be synthetically produced from sodium silicate and sulfuric acid, or silica gel may be formed by partially dehydrating polymeric colloidal silicic acid. Silica gel is amorphous and has a microporous distribution and network of pores (or capillaries). The pores may constitute openings of between three (3) to sixty (60) angstroms, with the average dimensions of the openings for the pores being around twenty-four (24) angstroms. In ambient conditions or near room temperature, such as around 77° F. or 25° C., and where the relative humidity is at or between around seventy percent (70%) or ninety percent (90%), the silica gel may adsorb up to a maximum of around forty percent (40%) of the silica gel's weight in moisture. As temperature rises in the environment in which the silica gel is exposed, particularly where the temperature exceeds around 100° F., the silica gel's capacity for moisture absorption decreases, thereby rendering silica gel a relatively poor desiccant in high-temperature conditions. Given that the size of the pores (or capillaries) of the silica gel may range from between three (3) to sixty (60) angstroms, the silica gel may adsorb compounds other than water vapor, including ammonia, alcohols, aromatics, diolefins, olefins, and/or paraffins.

In other embodiments, the desiccant 40 may include montmorillonite clay. Montmorillonite clay is a naturally occurring porous adsorbent that is typically fabricated or created by the controlled or regulated drying of magnesium aluminum silicate of the sub-bentonite formulation. In ambient conditions or near room temperature, such as around 77° F. or 25° C., and where the relative humidity is at or around ninety percent (90%), montmorillonite clay may adsorb up to a maximum of around twenty-seven percent (27%) or twenty-eight percent (28%) of the montmorillonite clay's weight in moisture. As temperature rises in the environment in which the montmorillonite clay is exposed, particularly where the temperature begins to exceed 100° F., the montmorillonite clay's capacity for absorption drastically decreases, thereby rendering montmorillonite clay a very poor desiccant in high-temperature conditions. Nevertheless, despite its poor performance in high-temperature conditions, montmorillonite clay is an inexpensive desiccant material and regenerates without substantial deterioration. Clays other than montmorillonite clay, containing at least one of (or a combination of) silica, aluminum oxide, magnesium oxide, calcium oxide, and ferric oxide, may also be the desiccant material.

In other embodiments, the desiccant 40 may include molecular sieve, which may also be referred to as synthetic zeolite. Molecular sieve is a synthetic form of porous crystalline aluminosilicates. Like silica gel, molecular sieve has a microporous distribution and network of pores, with various forms of molecular sieve having different dimensions of openings, including three (3) angstroms, four (4) angstroms, five (5) angstroms, and ten (10) angstroms. The different dimensions of openings enable a user of the molecular sieve to select which compounds, other than water vapor, the user desires to exclude from absorption into the pores of the molecular sieve. In ambient conditions or near room temperature, such as around 77° F. or 25° C., and where the relative humidity is at or around ninety percent (90%), molecular sieve may adsorb up to a maximum around twenty-two percent (22%) or twenty-three (23%) of the molecular sieve's weight in moisture. As temperature rises in the environment in which the molecular sieve is exposed, however, molecular sieve maintains absorption of moisture at a rate and quantity greater than that of silica gel and montmorillonite clay. For example, between 200° F. and 300° F., silica gel and montmorillonite clay may have an absorption capacity less than three percent (3%) by weight in moisture, whereas molecular sieve may have an absorption capacity between around seven (7%) and fifteen (15%) by weight in moisture. Moreover, while molecular sieve may not have a greater absorption capacity than silica gel or montmorillonite clay, molecular sieve adsorbs a higher threshold of moisture in relatively non-humid environments. For example, where the humidity is approximately ten percent (10%) in an environment, silica gel and montmorillonite clay may adsorb around five percent (5%) and seven percent (7%) of their weight in moisture respectively, whereas molecular sieve may adsorb around fifteen percent (15%) of the molecular sieve's weight in moisture.

In other embodiments, the desiccant 40 may include calcium sulfate (CaSO₄), which may be referred to commercially as Drierite®. Calcium sulfate is created or fabricated by a controlled or regulated dehydration of gypsum, a soft sulfate mineral comprising calcium sulfate dihydrate. While calcium sulfate is an inexpensive, chemically stable, non-disintegrating, and non-toxic substance, calcium sulfate is quite poor in adsorbing a percentage of its weight in moisture. In ambient conditions or near room temperature, such as around 77° F. or 25° C., and where the relative humidity is at or around ninety percent (90%), calcium sulfate may adsorb up to a maximum of around ten percent (10%) of the calcium sulfate's weight in moisture. Thus, calcium sulfate is usually not a desirable desiccant, presenting only few benefits in high- or low-temperature environments or relatively high- or low-humidity conditions.

In other embodiments, the desiccant 40 may include calcium oxide (CaO), which is calcinated or recalcinated lime, and otherwise referred to as “quicklime.” Calcium oxide is a relatively inexpensive desiccant material and is fairly effective at retaining moisture in high-temperature environments. In ambient conditions or near room temperature, such as around 77° F. or 25° C., and where the relative humidity is at or around ninety percent (90%), calcium oxide may adsorb up to a maximum of around thirty percent (30%) of the calcium oxide's weight in moisture. Moreover, while CaO may not have a greater absorption capacity than silica gel or a greater retention of moisture at higher conditions than molecular sieve, CaO adsorbs a substantially higher threshold of moisture in relatively non-humid environments. For example, where the humidity is at approximately ten percent (10%) in an environment, montmorillonite clay and molecular sieve may adsorb around seven percent (7%) and fifteen percent (15%) of their weight in moisture respectively, whereas calcium oxide may adsorb around twenty-six (26%) of calcium oxide's weight in moisture.

In further embodiments, the desiccant 40 may include activated alumina. Activated alumina is manufactured and fabricated from aluminum hydroxide by dehydroxylating the aluminum hydroxide, such that the activated alumina may have a porous structure. Activated alumina performs similarly to silica gel, and may demonstrate improved absorption capacity at higher temperature than silica gel.

The disclosure herein identifies and describes a limited number of desiccant materials of which the desiccant 40 may include. The limited number of desiccant materials disclosed and described herein are merely representative, and do not flag, signal, or indicate the universe of desiccant materials of which the desiccant 40 may include.

To facilitate the understanding of the embodiments described herein, a number of terms have been defined above. The terms defined herein have meanings as commonly understood by a person of ordinary skill in the areas relevant to the present invention. The terminology herein is used to describe specific embodiments of the invention, but their usage does not delimit the invention, except as set forth in the claims.

The terms “connected,” “attached,” “mounted,” and the like, or any variation thereof, should generally be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Terms such as “a,” “an,” and “the” are not intended to refer to only a singular entity, but rather include the general class of which a specific example may be used for illustration.

The phrases “in one embodiment,” “in optional embodiment(s),” “in alternative embodiment(s),” and “in an exemplary embodiment,” or variations thereof, as used herein do not necessarily refer to the same embodiment, although it may.

As used herein, the phrases “one or more,” “at least one,” or variations thereof, when used with a list of items, mean that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements, and/or states are in any way required for one or more embodiments, whether these features, elements, and/or states are included or are to be performed in any particular embodiment.

The previous detailed description has been provided for the purposes of illustration and description. Thus, although there have been described particular embodiments of new and useful HIGH-CAPACITY DESICCANT BREATHER, it is not intended that such references be construed as limitations upon the scope of this disclosure except as set forth in the following claims. Thus, it is seen that the apparatus of the present disclosure readily achieves the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims.

What is claimed is:

1. A breather comprising:
a breather housing configured to receive at least an air flow containing moisture;
a desiccant material contained within the breather housing and enclosed by a breather wall; and
a moisture indicator located within the breather housing and positioned between the desiccant material and an internal side of the breather wall, the moisture indicator providing a visible representation of an amount of moisture adsorbed by the desiccant material.

2. The breather of claim 1, wherein:
the visible representation of the moisture indicator is visually observable through the breather wall.

3. The breather of claim 1, wherein:
the visible representation of the moisture indicator comprises a change in color of the moisture indicator, the change in color correlated to the amount of moisture adsorbed by the desiccant material.

4. The breather of claim 3, wherein:
the change in color of the moisture indicator comprises at least a first color, a second color, and a third color,
the first color corresponding to a generally minimal amount of moisture adsorbed by the desiccant material,
the second color corresponding to an intermediate amount of moisture adsorbed by the desiccant material, and
the third color corresponding a generally maximum amount of moisture adsorbed by the desiccant material.

5. The breather of claim 3, wherein:
the change in color of the moisture indicator comprises at least a first color and a third color,
the first color corresponding to a generally minimal amount of moisture adsorbed by the desiccant material, and
the third color corresponding a generally maximum amount of moisture adsorbed by the desiccant material.

6. The breather of claim 1, wherein:
the visible representation of the moisture indicator comprises a gradient line, the gradient line correlated to an amount of moisture adsorbed by the desiccant material.

7. The breather of claim 1, wherein:
the moisture indicator is coated or deposited onto at least a portion of the internal side of the breather wall.

8. The breather of claim 1, wherein:
the moisture indicator is on a film, the film positioned against at least a portion of the internal side of the breather wall.

9. The breather of claim 1, wherein:
the moisture indicator is on a blotting sheet, the blotting sheet positioned against at least a portion of the internal side of the breather wall.

10. A breather comprising:
a breather housing configured to receive at least an air flow containing moisture;
a desiccant material contained within the breather housing and enclosed by a transparent breather wall, the desiccant material substantially without a color-indicating formulation; and
a moisture indicator located within the breather housing and positioned between the desiccant material and an internal side of the transparent breather wall, the moisture indicator providing a visible representation of an amount of moisture adsorbed by the desiccant material.

11. The breather of claim 10, wherein:
the visible representation of the moisture indicator comprises a color differential correlated to the amount of moisture adsorbed by the desiccant material.

12. The breather of claim 10, wherein:
the visible representation of the moisture indicator comprises at least a first indication of an amount of moisture adsorbed by the desiccant material, a second indication of an amount of moisture adsorbed by the desiccant, and a gradient line, the gradient line between the first indication and the second indication, and the gradient line correlated to an amount of moisture adsorbed by the desiccant material of the breather.

13. The breather of claim 10, wherein:
the moisture indicator is coated or deposited onto at least a portion of the internal side of the transparent breather wall.

14. The breather of claim 10, wherein:
the moisture indicator is coated or deposited onto a film, the film positioned against at least a portion of the internal side of the transparent breather wall.

15. The breather of claim 10, wherein:
the moisture indicator is on a blotting sheet, the blotting sheet positioned against at least a portion of the internal side of the transparent breather wall.

16. The breather of claim 10, wherein:
the desiccant material comprises at least one of colorless silica gel, molecular sieve, montmorillonite clay, calcium sulfate (CaSO₄), calcium chloride (CaCl₂), calcium oxide (CaO), activated alumina, silica alumina, various pore-sized silica gel, metal-organic framework, or activated carbon, and combinations thereof.

17. The breather of claim 10, wherein:
the desiccant material is configured to adsorb up to about forty percent (40%) of the desiccant material's weight in moisture.

18. A method of visually conveying a saturation of moisture of a desiccant material contained within a breather, the method comprising the steps of:
receiving at least an air flow containing moisture into a breather housing of the breather, the breather housing having the desiccant material contained therein and the desiccant material enclosed by a breather wall;
capturing moisture from the air flow containing moisture into the desiccant material; and
providing a visible indication of the saturation of moisture within desiccant material by a moisture indicator adjacent the desiccant material, the visible indication observable through the breather wall.

19. The method of 18, wherein:
the visible indication is correlated to amount of moisture adsorbed by the desiccant material.

20. The method of 18, wherein:
providing the visible indication further comprises producing a gradient line interposed between a first and second indication of an amount of moisture adsorbed by the desiccant material, the gradient line correlated to an amount of moisture adsorbed by the desiccant material indicative of an amount of moisture.

21. The method of 18, wherein:
the desiccant material is configured to achieve a maximum absorption of the desiccant material's weight in moisture at a rate between about 15% to about 45% slower than if the desiccant material contained a color-indicating formulation.
